(19) United States
(12) Patent Application Publication
(10) Pub. No.: US 2015/0086938 A1
(43) Pub. Date: Mar. 26, 2015

(54) ATTACHMENT FOR A PHOTOPOLYMERIZATION DEVICE AND CHARGING STATION THEREFORE

(71) Applicant: Heraeus Kulzer GmbH, Hanau (DE)

(72) Inventor: Stephan Schmid, Glauburg (DE)

(73) Assignee: Heraeus Kulzer GmbH, Hanau (DE)

(21) Appl. No.: 14/391,515

(22) PCT Filed: Apr. 11, 2013
(86) PCT No.: PCT/EP2013/057551

§ 371 Date: Oct. 9, 2014

(30) Foreign Application Priority Data
Apr. 13, 2012 (DE) 10 2012 007 300.3

(51) Int. Cl. A61C 13/15; H02J 7/00

(52) U.S. Cl. CPC A61C 19/004; H02J 7/0042
USPC 433/29; 320/114; 320/166

(57) ABSTRACT

A photopolymerization apparatus comprising a charging station and a hand-guidable photopolymerization device, wherein the photopolymerization device comprises at least one reservoir for electrical power and at least one attachment having at least one charging contact, wherein at least one of (i) the at least one attachment is securable to the charging station and (ii) the at least one attachment is securable to the photopolymerization device, wherein the attachment provides at least one electrically conductive connection by means of which the at least one reservoir is rechargeable.

The invention relates to a charging station for a wireless photopolymerization device for curing of light-polymerizable dental materials, whereby the photopolymerization device comprises a reservoir for electrical power, in particular an accumulator/rechargeable battery or a capacitor, and whereby the charging station comprises at least one electrically conductive charging contact by means of which an electrically conductive connection to an electrically conductive mating charging contact of the photopolymerization device for charging the reservoir for electrical power is established, when the photopolymerization device is connected to the charging station.

The invention also relates to a wireless photopolymerization device for curing of light-polymerizable dental materials, whereby the photopolymerization device comprises a reservoir for electrical power, in particular a rechargeable battery or a capacitor, and whereby the photopolymerization device comprises at least one electrically conductive charging contact by means of which an electrically conductive connection to an electrically conductive mating charging contact of a charging station for the photopolymerization device can be established for charging the reservoir when the photopolymerization device is connected to the charging station.

Furthermore, the invention relates to an attachment for connecting a wireless photopolymerization device to a charging station and a photopolymerization device comprising a charging station, a hand-guidable photopolymerization device, and an attachment.

Photopolymerization devices are used for curing dental restoration materials. The dental restoration materials are plastic materials, and are used, for example, to produce plastic fillings, dentures or parts thereof, whereby the photopolymerization device irradiate the dental restoration materials with light of an appropriate wavelength and the plastic material is cured by the irradiation.

A photopolymerization device in the form of a dental hand-piece having a housing and, disposed therein, an LED as a light source that emits blue light, is known from DE 20 2004 001 189 U1. The photopolymerization device comprises a rechargeable battery, which is used to operate the LED. Said rechargeable batteries are charged by plugging the photopolymerization device into a charging station, which is connected to the mains supply by means of a lead in order to charge the rechargeable battery of the photopolymerization device. Plugging the photopolymerization device into the charging station, the electrical charging contacts of the photopolymerization device and of the charging station become connected to each other.

Charging contacts for Li-ion rechargeable batteries are commonly designed for low voltages (<10 V DC) and low currents (<1 A DC) designed, resulting in a high quality contact design. Pin, spring lever, and sliding contacts are known for this purpose. Charging contacts are subject to natural wear with heavy use and aging or soiling resulting from the application. By proper design and selection of materials, such as a gold coating of the charging contacts, the wear can be reduced but not prevented. Similarly, cleaning efforts by the user are not expedient as this may damage the charging contact or its surface. Thus far, charging stations for photopolymerization devices use fixed charging contacts, contact pairs or strips, which interrupt the charging function in the presence of wear or defect and thus render the entire charging station or the photopolymerization device unusable.

This is disadvantageous in that the electrical charge contacts for charging the rechargeable battery wear out, and therefore the life of the charging stations and photopolymerization devices is limited or at least there is a need to repair parts of the devices.

Therefore, the object of the invention is to overcome the disadvantages of the prior art. In particular, a way is be found to reduce the effort caused by the wear of the charging contacts. In this context, the cost, in particular, as caused by the repair of the charging contacts, is to be reduced.

The object of the invention is solved by a charging station for a wireless photopolymerization device for curing of light-polymerizable dental materials, whereby the photopolymerization device comprises a reservoir for electrical power, in particular an accumulator such as a rechargeable battery or a capacitor, and whereby the charging station comprises at least one electrically conductive charging contact by means of which an electrically conductive connection to an electrically conductive mating charging contact of the photopolymerization device for charging the is established when the photopolymerization device is connected to the charging station, wherein the electrically conductive charging contact is part of an attachment that can be or is secured to the charging station in releasable manner, whereby the electrically conductive charging contact in the attachment is connected in electrically conductive manner to at least one second electrically conductive charging contact of the charging station, when the attachment is secured to the charging station.

According to the invention, a wireless photopolymerization device shall not be understood to mean a device having a design that is completely free of leads, but rather a device that is not connected to an external power source, such as an electrical outlet, by means of a lead for the purpose of supplying power. Preferably, the wireless photopolymerization device can be guided by hand. Then, the device can easily be inserted with one hand. A charging contact of the attachment shall be understood to mean both the part, which provides an electrical connection through a mating contact as well as the connection from one to the next point of contact in the attachment.

Charging stations according to the invention can be provided with the electrically conductive connection being a plug-in connection.

Plug-in connections are simple and inexpensive to implement and are easy to operate.

Furthermore, the invention can provide the attachment to comprise a securing element by means of which the attachment can be or is secured to the charging station, whereby the securing element preferably is a thread engaging a mating thread of the charging station, and/or the securing element is at least one screw by means of which the attachment can be or is screwed to the charging station.

By means of said securing elements, a stable connection of the attachment to the charging station can be produced that withstands even the mechanical stresses of a plug-in process.

According to a further embodiment, the invention can provide the attachment to be lockable or locked to the charging station and/or the attachment and the charging station to form a bayonet closure.

Said securing means can be connected easily and quickly and therefore provide for enhanced ease of use.

According to a further particularly advantageous embodiment, the invention can provide that at least one charging contact, preferably the electrically conductive charging contact of the attachment, comprises a coating, at least partially, preferably a refinement, particularly preferably a noble metal coating, and/or that the attachment comprises two charging contact pins or a USB port that include the charging contact.

This design attains stable and reliable electrical contacting. In this context, of course, only the parts of the charging contact comprising a surface that may contact a mating contact need to be coated. The wiring on the inside of the attachment is not coated.

The objects of the invention are also solved by a wireless photopolymerization device for curing photo-polymerizable dental materials, whereby the photopolymerization device comprises a reservoir for electrical power, in particular a rechargeable battery or a capacitor, and wherein the photopolymerization device comprising at least one electrically conductive charging contact by means of which an electrically conductive connection to an electrically conductive mating charging contact for the photopolymerization device for charging the reservoir can be established, when the photopolymerization device is connected to the charging station, in which the electrically conductive charging contact is part of an attachment that can be or is secured in releasable manner to the photopolymerization device, whereby the electrically conductive charging contact in the attachment is connected, in electrically conductive manner, to at least one second electrically conductive charging contact in the photopolymerization device, when the attachment is secured to the photopolymerization device.

The invention can provide the electrically conductive connection to be a plug-in connection in this context.

Further, the invention can provide the attachment to comprise a securing element by means of which the attachment can be or is secured to the photopolymerization device, whereby the securing element preferably is a thread that engages a mating thread of the photopolymerization device, and/or the securing element is at least one screw by means of which the attachment can be or is screwed to the photopolymerization device.

According to a further particularly preferred embodiment, the invention can provide that the attachment can be or is locked to the photopolymerization device and/or that the attachment and the photopolymerization device form a bayonet closure.

The advantages of these last embodiments are the same as those described with regard to the attachment to the charger.

Further, the invention can provide the photopolymerization device to comprise a light source, preferably an LED, for curing a polymerizable plastic material that preferably emits light of a wavelength between 380 nm to 500 nm, more preferably comprising at least two wavelength peaks, most preferably between 400 nm and 405 nm and 455 nm and 460 nm.

These wavelengths are particularly well suited to achieve photopolymerization. These wavelengths are particularly well suited, in particular for dental plastics.

The invention can also provide the LED light source to emit in a power range of 800 mW/cm² to 2000 mW/cm², preferably between 1200 mW/cm² and 1800 mW/cm².

The invention can also provide the photopolymerization device to comprise charge control electronics by means of which the charging of the reservoir for electrical power is controlled or regulated.

The integration of the charge control electronics (control) into the hand-piece, i.e. into the photopolymerization device, is advantageous in that a compact design is ensured and the charge control electronics can directly access the accumulator or the reservoir for electrical energy.

Photopolymerization devices according to the invention can also be provided appropriately such that at least one charging contact, preferably the electrically conductive charging contact of the attachment, comprises a coating, at least partially, preferably a refinement, particularly preferably a noble metal coating, and/or that the attachment comprises two charging contact pins or a USB port, which include the charging contact.

The objects of the invention are also solved by an attachment for connecting a wireless photopolymerization device to a charging station, whereby the attachment is suitable for being secured to said charging station and/or to said photopolymerization device.

Another solution of the objects of the invention can be implemented through a photopolymerization apparatus comprising a charging station, particularly a charging station according to the invention, a hand-guidable photopolymerization device, in particular a photopolymerization device according to the invention, whereby the photopolymerization device comprises at least one reservoir for electrical power, preferably a rechargeable battery, and the photopolymerization device comprises at least one attachment having a charging contact and whereby the attachment or attachments can be or are secured to the charging station and/or the attachment or attachments can be or are secured to the photopolymerization device, whereby the attachment provides or the attachments provide at least one electrically conductive connection by means of which the reservoir for electrical power can be charged.

In all embodiments having a rechargeable battery in the photopolymerization device, the invention can provide that the rechargeable battery to be a Li-ion rechargeable battery.

The invention is based on the surprising finding that, having a replaceable attachment with the charging contact integrated into it, it is feasible to provide a photopolymerization device or a charging station for said photopolymerization device, in which the charging contact can be renewed simply by replacing the attachment. By integrating the wearing pars, namely the charging contact, into an easily replaceable attachment, is becomes feasible to avoid costly repair of the photopolymerization device and/or of the charging station for the photopolymerization device.

The invention is therefore based on the surprising rationale to sub-divide the actual charging contact (bracket, pin, clip, spring, etc.) into two contacts that are arranged successively and to implant the wearing working contact (charging station versus photopolymerization device/hand piece) by means of a mountable attachment (adapter or insert) in simple manner even for untrained users. The cascade contacts thus formed thus have an increased service life and can be replaced by the user of the photopolymerization device any number of times according to need.

Charging contacts according to the prior art are firmly connected to the charging station or to the photopolymerization device and/or its electronics to the effect that said charging stations and photopolymerization devices need to be replaced or repaired by the manufacturer or a service engineer if a defect occurs. Considering the price of the contact materials versus the resulting effort, this is an inefficient approach as compared to charging stations and photopolymerization devices according to the invention.

An example of a design according to the invention is a photopolymerization device for dental restoration materials including a photopolymerization device, as a hand-piece, having an LED light source, whereby the LED light source emits in a single-or multiple-wavelength range(s) from 380 nm to 500 nm, in particular with at least two wavelengths peaks, preferably in two wavelength ranges of 400 nm to 405 nm and 455 nm to 460 nm, whereby the LED light source emits in a power range from 800 mW/cm² to 2,000 mW/cm², preferably between 1,200 mW/cm² and 1,800 mW/cm², and the photopolymerization device comprises a replaceable and rechargeable accumulator, preferably Li-ion storage battery, in the hand-piece, which can be charged with electrical voltage or to which voltage can be applied by a separate base station or charging station of the photopolymerization device, whereby

the photopolymerization device is designed to have at least two charging contact parts in the hand-piece and/or the charging station in the form of cascade contacts;

the working contacts are integrated in an attachment such as an adapter or an insert which is replaceable by simple activities by the customer;

the voltage is supplied to the charging station by means of USB ports; and

charge control electronics, which is situated completely in the hand-piece.

The contacting of the cascade is implemented in the manner of a series circuit, wherein the charging contacts are connected in series.

The present invention shifts the “wearing charging contact” into its own integrated but easily removable part of the housing (the attachment), which in turn is connected by means of the same- or different-type charging contacts to the actual charger housing.

In the following, further embodiments of the invention shall be illustrated with reference to four schematic figures, without, however, limiting the invention. In the figures:

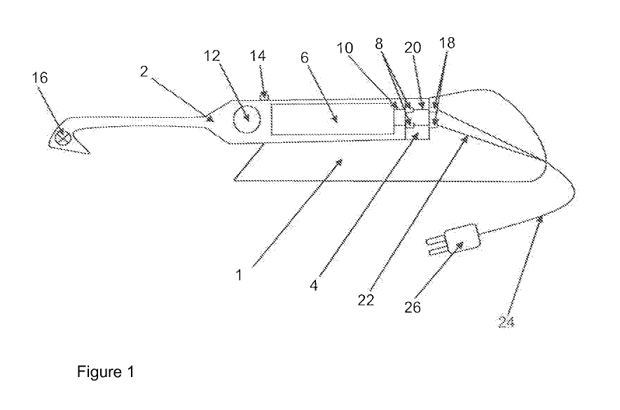

FIG. 1: shows a schematic cross-sectional view of a photopolymerization apparatus according to the invention comprising a photopolymerization device, a charging unit, and an attachment;

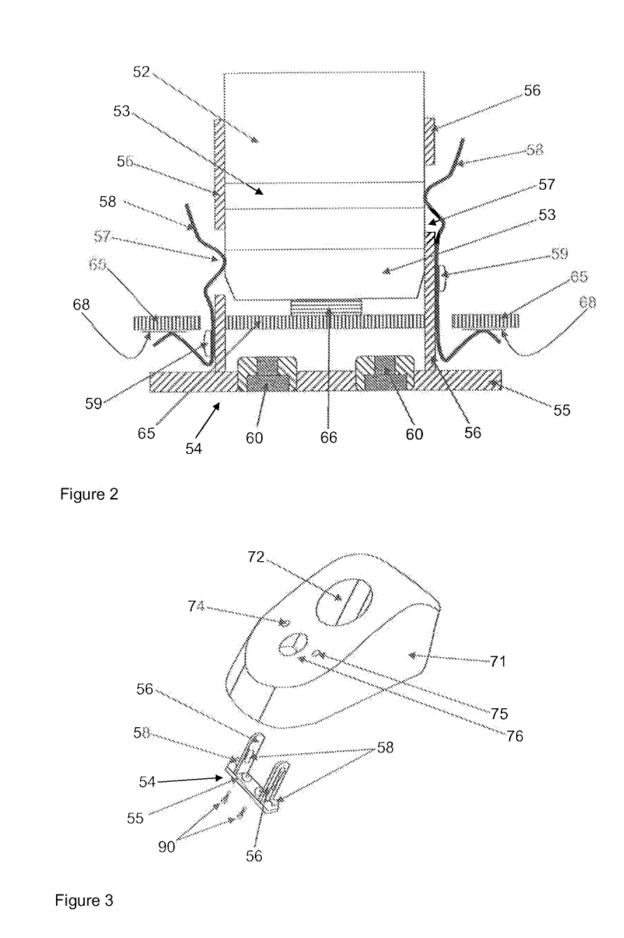

FIG. 2: shows a schematic cross-sectional view of a particularly preferred embodiment of an attachment according to the invention inserted into a charging station, in which the photopolymerization device is inserted;

FIG. 3: shows a schematic perspective view of a charging station according to the invention having an unsecured attachment according to the invention; and

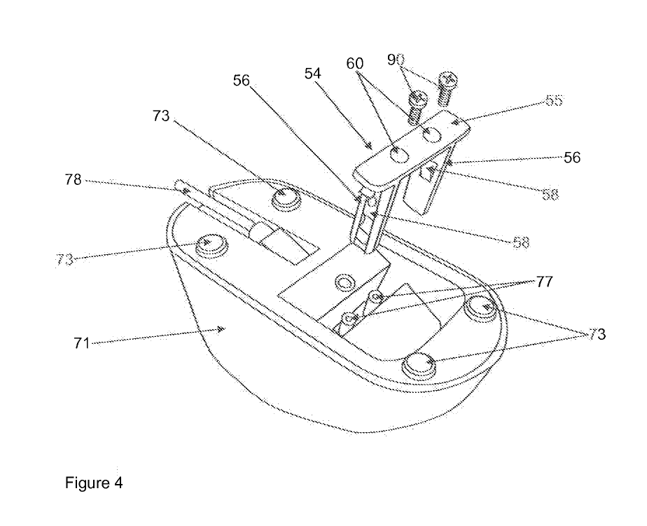

FIG. 4: shows a schematic perspective view of the underside of the charging station according to the invention according to FIG. 3 with an attachment according to the invention being ready to be inserted.

FIG. 1 shows a schematic cross-sectional view of a photopolymerization apparatus according to the invention comprising a charging station 1 that is connected to a power grid, a hand-guidable photopolymerization device 2, and an attachment 4. The photopolymerization device 2 (hand-piece) comprises a replaceable battery 6 in its housing in the area of a handle body, which is adapted to be held in one hand. Preferably, the rechargeable battery is a Li-ion rechargeable battery. The bottom end of the photopolymerization device 2 has a first electrical charging contact 8 arranged on it, which comprises two metal pins and thus is formed in the manner of a plug. The charging contact 8 is connected by means of two electric leads 10 to the rechargeable battery 6, so that rechargeable battery 6 can be charged when an electrical voltage is applied to the metal pins of the electrical charging contact 8.

A controller 12 is arranged inside the handle of the photopolymerization device 2, inter alia, for controlling the charging process of the rechargeable battery 6. In addition, the controller 12 is suitable for processing signals from an input facility 14, which can just as well be a simple switch or a rotary switch. The input facility 14 can be used, at least, to turn the photopolymerization device 2 on and off, whereby preferably the power of the emitted light and/or the duration of the illumination is/are adjustable as well. The controller 12 can also be used to control a display facility (not shown), such as, for example, one or more LEDs, such that the user can see whether or not the photopolymerization device 2 is just being loaded and/or whether the photopolymerization device 2 is fully charged. The controller 12 also processes the signals from the input facility 14 and uses them as the basis to control an LED 16 that can be used to emit white or blue light that is suitable for curing a polymerizable plastic material.

The photopolymerization device 2 is plugged by means of the metal pins into the attachment 4, which comprises two metal-lined recesses for the metal pins of the first charging contacts 8 in the appropriate places for this purpose. The recesses in the attachment can comprise resilient, elastic metal brackets such that a spring contact is formed. The recesses are connected by electrical lines 20 in the attachment 4 to an electrical charging contact 18 of the attachment 4, which comprises two metal pins. The resilient, elastic metal brackets are also part of the charging contact 18 of the attachment. The attachment 4 thus forms a cascade plug.

The attachment 4 is plugged by means of the metal pins 18 into electrically conducting recesses of the charging station 1, and is secured by means of a thread (not shown) to a mating thread of the charging station 1 (not shown). The charging station 1 is essentially a stand that allows the charging station 1 to be set up stably. Likewise, the charging station 1 can, however, also be secured to a bracket on a wall or a pole. Two electrical lines 22, which extend on the interior of the charging station 1, connect the recesses of the charging station 1 in electrically conductive manner to a power cord 24 which terminates in a mains plug 26 by means of which the charging station 1 can be connected to a socket for a common mains supply. If applicable, a transformer (not shown) can be provided in the charging station 1, power cable 24 or mains plug 26.

When the photopolymerization device 2 is connected to the charging station 1 by means of the attachment 4, the rechargeable battery 6 is charged as controlled by the controller 12. If the metallised recesses in the attachment 4 are worn out by frequent use, the attachment 4 can be unscrewed from the charging station 1 and simply replaced by a new attachment 4 with intact recesses. Because of the ease of replacement of the attachment 4, it is particularly advantageous for the invention to provide that the metals and/or coating of the recesses of the attachment 4 are less hard than the metal pins of the charging contact 8 of the photopolymerization device 2, such that the charging contact 8 wears only slowly and the signs of wear and tear occur mainly on the recesses of the replaceable attachment 4.

As an alternative to the illustrated embodiment, the attachment 4 could be also firmly connected to the photopolymerization device 2. However, this increases the weight of the photopolymerization device 2 that is to be held by hand. Therefore, it is prefered to secure the attachment 4 to the charging station 1 in order to keep the weight of the hand-guided photopolymerization device 2 as low as possible.

Moreover, the invention could provide for securing an attachment 4 each on both the photopolymerization device 2 as well as on the charging station 1. The wear and tear of the charging contacts then occurs only in the recesses of the first attachment 4 on the charging station 1 and the charging contacts (metal pins) of the second attachment (not shown). This design allows wear and tear of the charging contacts of the photopolymerization device 2 and of the charging station 1 to be strictly prevented. This embodiment is particularly preferred as a general principle for all embodiments of the invention and shall not be limited to the present embodiment. To ensure good electrical contact, the recesses and the metal pins can be finished with a metal layer that prevents oxidation of the surfaces of the contacts. Oxidation would lead to a deterioration of the electrical contact. In this context, it is not necessary to use costly gold coatings or similarly costly noble metal coatings since the longevity of the recesses and charging contacts 18 of the attachments 4 is not essential. This shall also be understood as a preferred general principle according to the invention and is not limited to the present embodiment.

FIG. 2 shows a schematic cross-sectional view of a particularly preferred embodiment of an attachment 54 according to the invention inserted into a charging station (of which only a board 65 is shown in FIG. 2) with inserted photopolymerization device 52 of which only the lower part is shown in FIG. 2. The photopolymerization device 52 comprises two metallic ring contacts 53 as charging contacts, which are electrically insulated from each other and are connected to a rechargeable battery (not shown) inside the photopolymerization device 52. The rechargeable battery can be charged by means of the ring contacts 53 by applying an electrical voltage, which is or can be controlled through a controller (not shown) of the photopolymerization device 52.

The attachment 54 comprises a bar 55 and two charging contact pins 56 made of plastic. The plastic parts can be manufactured through an injection moulding process. On recess 57 each is provided in the charging contact pins 56 and has two charging contacts 58 of the attachment 54 extend through them, which thus make electrical contact with the ring contacts 53 of inserted photopolymerization device 52. The charging contacts 58 are narrow, arcuate, preloaded metal tapes (charging contact springs) secured to the charging contact pins 56 by means of a fixation 59. The fixation 59 can be implemented by means of screws or rivets. In principle, a firm gluing is conceivable as well.

Two reinforced recesses 60 are provided as screw holes 60 in the bar 55. The attachment 54 can be firmly connected to the charging station through said screw holes 60. For this purpose, the charging station comprises two matching recesses with internal threads (not shown). The charging contact pins 56 with the charging contacts 58 reach through two recesses of a circuit board 65 of the charging station. A spacer 66 is provided on the circuit board 65 and ensures that the fully inserted photopolymerization device 52 is in correct position by defining a limit stop. Two metallic contact surfaces 68 are provided on the circuit board 65 as charging contacts of the charging station. The circuit board 65, the spacer 66, and the contact surfaces 68 are part of the charging station to which they are firmly and rigidly connected. When the attachment 54 is secured to the charging station, one end each of the metal leaf spring 58 presses against the contact surfaces 68, thus establishing an electrically conductive connection between the charging contact 58 of the attachment 54 and the electrical lines of the charging station connected to the contact surfaces 68. When the photopolymerization device 52 is being plugged into a recess (not shown) in the charging station provided for this purpose, the respective other ends of the charging contact spring 58, or a curvature of the charging contact spring 58 on the other side of the fixation 59, press against the ring contacts 53 of the photopolymerization device 52, thus establishing an electrical connection between the ring contacts 53 and the contact surfaces 68 by means of the charging contact 58.

The contact surfaces 68 are connected to a mains grid or any other voltage source by connecting the charging station to a power outlet by means of the electric leads and a cable and a power plug.

FIG. 3 shows a schematic perspective view of a charging station 71 according to the invention having a non-secured attachment 54 according to the invention. The design of the attachment 54 is the same as that of the attachment shown in FIG. 2 54 The attachment 54 comprises a bar 55 as a base, in which two feed-throughs for two screws 90 are provided by means of which the attachment 54 can be secured from below in the bottom of the charging station 71.

Two charging contact pins 56 bearing the charging contact springs 58 and/or the charging contact 58 of the attachment 54 are arranged at a right angle to the bar 55. The bar 55 and the charging contact pins 56 are manufactured in one piece from plastic material. The attachment 54 is inserted from below into the charging station 71 in the area of one recesses 72 for insertion of a photopolymerization device (not shown) and secured in this place with the screws 90. The drawn lines in the recess 72 and at the front of the charging station 71 are intended to merely indicate, in a perspective view, the orientation of the walls and have no further meaning presently. A rail could be provided in this area just as well, though, which allows for the insertion of a photopolymerization device hand-piece to take place in one orientation only. The recess 72 has a circular cross section.

The charging station 71 comprises a light-emitting diode (=LED) 74 that serves to display the charging status of the reservoir for electrical power of an inserted photopolymerization device. In addition or alternatively, the LED 74 serves as an indicator of a connected voltage supply by means of a power cord 78. The LED 75 serves as an indicator of the light intensity measured with a sensor 76.

FIG. 4 shows a schematic perspective view of the underside of the inventive charging station 71 according to FIG. 3 having an attachment 54 according to the invention that is ready to be inserted. As is evident from FIG. 4, the attachment 54 is being inserted into a matching recess on the underside of the charging station 71. Accordingly, the attachment 54 could also be called insert 54. The charging contact pins 56 extend through a circuit board (not shown) that bears the charging contacts in the form of two contact surfaces (not shown) of the charging station 71, as shown in FIG. 2, and extend into the recess 72 (which is shown in FIG. 3). Here, the leaf springs of the charging contacts 58 can be associated with mating contacts of a photopolymerization device by inserting the photopolymerization device into the recess 72. The contact surfaces of the charging station are contacted by the other ends of the leaf springs of the charging contacts 58. The contact surfaces are connected by means of a power cord—also called power lead—78 to a voltage source.

The attachment 54 is secured by means of the screws 90, which are passed through screw holes 60, to the threaded holes 77, which comprise a mating thread for the screws 90.

Four rubber feet 73 are arranged on the underside of the charging station 71 and ensure secure footing of the charging station 71 even during insertion and removal of the photopolymerization device.

The features of the invention disclosed in the foregoing description, as well as in the claims, figures and exemplary embodiments, can be essential for the implementation of the various embodiments of the invention both individually and in any combination.

### LIST OF REFERENCE NUMBERS

1, 71 Charging station
2, 52 Photopolymerization device
4, 54 Attachment insert
6 Reservoir, in particular accumulator, Rechargeable battery
8, 18 Charging contact
10, 20, 22 Electrical line
12 Controller
14 Input device switch rotary switch
16 LED for photopolymerization
24, 78 Cable or power cord
26 Plug
53 Ring contact
55 Bar
56 Charging contact pin
57 Recess
58 Charging contact spring leaf spring
59 Fixation
60 Screw hole
65 Circuit board
66 Spacer
68 Contact surface
72 Receptacle for photopolymerization device handheld unit
73 Stand
74 LED indicating the applied voltage supply
75 Indicator of the light intensity measured with a sensor 76
76 Sensor
77 Threaded hole
78, 24 Power cord or cable
90 Screw

1. A charging station for a wireless photopolymerization device, wherein the photopolymerization device comprises a reservoir for electrical power, that comprises an accumulator or a capacitor, wherein the charging station comprises at least one first electrically conductive charging contact by means of which an electrically conductive connection to an electrically conductive mating charging contact of the photopolymerization device for charging the reservoir is establishable, when the photopolymerization device is connected to the charging station, wherein
the at least one first electrically conductive charging contact is part of an attachment that is securable to the charging station in releasable manner, wherein the at least one electrically conductive charging contact in the attachment is connectable is electrically conductive manner to at least one second electrically conductive charging contact of the charging station, when the attachment is secured to the charging station.

2. The charging station according to claim 1, wherein the electrically conductive connection is a plug-in connection.

3. The charging station according to claim 1, wherein the attachment comprises a securing element by means of which the attachment is securable to the charging station, wherein the securing element is at least one of a thread engaging a mating thread of the charging station, and at least one screw by means of which the attachment is screwable to the charging station.

4. The charging station according to claim 1, wherein the attachment is lockable to the charging station (1, 71) or the attachment (4, 54) and the charging station form a bayonet closure.

5. The charging station according to claim 1, wherein the at least one first charging contact comprises at least one of:
an at least partial coating; and
two charging contact pins or a USB port that include the at least one first charging contact.

6. A wireless photopolymerization device for curing of light-polymerizable dental materials, wherein the photopolymerization device comprises a reservoir for electrical power, that comprises a rechargeable battery or a capacitor, wherein the photopolymerization device comprises at least one first electrically conductive charging contact by means of which an electrically conductive connection to an electrically conductive mating charging contact of a charging station for the photopolymerization device is producible for charging the reservoir, when the photopolymerization device is electrically connected to the charging station, wherein
the at least one first electrically conductive charging contact is part of an attachment that is securable to the photopolymerization device in releasable manner, wherein the at least one first electrically conductive charging contact in the attachment is connectable in electrically conductive manner to at least one second electrically conductive charging contact in the photopolymerization device, when the attachment is secured to the photopolymerization device.

7. The wireless photopolymerization device according to claim 6, wherein the electrically conductive connection is a plug-in connection.

8. The wireless photopolymerization device according to claim 6, wherein the attachment comprises a securing element by means of which the attachment is securable to the photopolymerization device, wherein the securing element is at least one of a thread engaging a mating thread of the photopolymerization device, and at least one screw by means of which the attachment is screwable to the photopolymerization device.

9. The wireless photopolymerization device according to claim 6, wherein the attachment is lockable to the photopolymerization device or the attachment and the photopolymerization device form a bayonet closure.

10. The wireless photopolymerization device according to claim 6, wherein the photopolymerization device comprises a light source for curing a polymerizable plastic material that emits light of a wavelength between 380 nm to 500 nm.

11. The wireless photopolymerization device according to claim 6, wherein the wireless photopolymerization device comprises charge control electronics by means of which charging of the reservoir for electrical power is at least one of controlled and regulated.

12. The wireless photopolymerization device according to claim 6, wherein the at least one first charging contact comprises at least one of:
a partial coating, and
two charging contact pins or a USB port that include the charging contact.

13. An attachment for connecting a wireless photopolymerization device to a charging station, wherein whereby the attachment is secured to the charging station according to claim 1.

14. A photopolymerization apparatus comprising the charging station, a hang-guidable photopolymerization device, wherein the photopolymerization device comprises at least one reservoir for electrical power and at least one attachment having at least one charging contact and wherein at least one of:
the at least one attachment is securable to the charging station, and
the at least one attachment is securable to the photopolymerization device,
wherein the attachment provides at least one electrically conductive connection by means of which the reservoir is rechargeable.

15. The charging station according to claim 5, wherein the coating is a refinement.

16. The charging station according to claim 5, wherein the coating is a noble metal coating.

17. The wireless photopolymerization device according to claim 10, wherein the light source is an light-emitting diode that emits light at a range between 400 nm and 405 nm.

18. An attachment for connecting a wireless photopolymerization device to a charging station, wherein the attachment is secured to the wireless photopolymerization device according to claim 6.
